(19) United States
(12) Patent Application Publication
(10) Pub. No.: US 2010/0153425 A1
(43) Pub. Date: Jun. 17, 2010

(54) Method for Counting Syllables in Readability Software

(76) Inventor: Yury Tulchinsky, Brooklyn, NY (US)

Correspondence Address: Russ Weinzimmer, 614 Nashua Street, Suite 53, Milford, NH, 03055, US

(21) Appl. No.: 12/333,304

(22) Filed: Dec. 12, 2008

(51) Int. Cl. G06F 17/30

(52) U.S. Cl. 707/765; 707/E17.017

(57) ABSTRACT

A software-implemented method is disclosed that can provide an accurate count of the number of syllables in each word of a body of text to be analyzed by readability software. If the software finds the word in a database, the syllable count is obtained from the database. If the software does not find the word in the database, the software asks a user to specify the number of syllables in the word. In preferred embodiments, the user can direct the software to add the target word and the associated syllable count to the database for future reference. As the software is used, the dictionary thereby grows and adapts to a specific user environment without need for a programmer to customize the software.

### FIELD OF THE INVENTION

The invention generally relates to methods for determining readability of text, and more specifically to software methods for determining the number of syllables in a word.

### BACKGROUND OF THE INVENTION

Language is basic to most communication. Whenever language is used, the communicator must make a choice as to the level of language that is to be employed, so that the sophistication of the vocabulary, sentence constructions, and such like can be adjusted accordingly. If the language level is too low, an item of communication may be overly long, and/or it may not be able to convey the nuances, or even the basic meaning, that the communicator wishes to convey. If the language level is too high, many of the intended recipients may not be able to fully comprehend what the communicator is trying to convey.

When speaking, for example, it is common to choose a higher language level when speaking to adults in their native language, and to choose a lower language level when speaking to children, or to someone with limited skills in the chosen language.

Some applications of language communication call for special care to be given to the choice of language level. Often in such cases, the item of communication is initially created in the form of written text, whether it is ultimately read by a recipient or delivered verbally to a recipient. Examples include textbooks, advertisements, classroom lectures, political speeches, radio announcements, usage and warning labels provided with pharmaceuticals and other products, medical consent forms, contracts, and even patents.

A writer of a textbook may wish to address a certain grade level. An educator may wish to select a textbook that is grade-level appropriate. An advertiser may wish to optimize the effectiveness of an advertisement by creating advertising text or a script for a radio or television commercial that is both entertaining and easy to comprehend, even when the recipient is not giving full attention to the advertisement.

Because an item of language communication can always be written down for purposes of language level analysis, items of language communication are referred to herein without loss of generality as items of text, and language level is referred to herein without loss of generality as “readability.”

For many applications, a mere qualitative sense of language level is not sufficient, and it becomes desirable or even necessary to quantify the readability of an item of text. Readability is often reported in terms of an equivalent reading level, or grade level. According to this system, text written at an “eighth grade” level should be readily comprehended by most people who have completed at east the eight grade in school.

Quantification of readability according to a reproducible formula and/or method can provide an objective and reproducible estimate of readability, which is useful in many circumstances, and can be critical when attempting to satisfy regulatory requirements. For example, the FDA has begun to issue guidelines and requirements with regard to readability and required language levels. In the spring of 2002, a US Food and Drug Administration speaker at a clinical trials conference announced that the FDA was requiring clinical-trial consent forms to be written at no more than a sixth-grade reading level. And the FDA recently issued readability guidelines for prescription drug labels, medical consent forms, and clinical trial consent forms.

A number of different formulae are in common use for determining the readability of text. Examples include the readability formulae referred to as Powers-Sumner-Kearl, Flesch Grade Level, FOG, SMOG, FRY graph, and FORECAST. Typically, these formulae operate on statistical data obtained from the text, such as the average sophistication of the words used (vocabulary), the average number of words contained in each sentence, the average number of syllables included in each word, and the total number of sentences in the text. The formulae are often implemented in software, whereby an item of text is accepted by the software and a score, often in the form of an equivalent “grade level” is returned.

Sentences and words are typically easy for software to distinguish, since they are generally separated by spaces and other punctuation. However, there is no simple way for a computer to differentiate syllables within a word. Often, a dictionary is used to match words and obtain therefrom the number of syllables in the word. However, the problem remains as to how a computer should evaluate words that are not found in an available dictionary.

Sometimes, various rules are applied in an attempt to estimate the number of syllables contained in a word not found in a dictionary. For example, an “s” added to a known word is considered not to add a syllable, while “ing” added to a known word is considered to add an additional syllable. However, in general these rules can provide only estimates, and lead to inaccuracies in syllable counts and resulting inaccuracies in readability scores. As readability determination has become more critical, the accuracy with which syllables are counted has become increasingly important.

### SUMMARY OF THE INVENTION

A software implemented method is claimed that provides an accurate count of the number of syllables in a word. The claimed syllable counting method can be implemented in readability determination software, so as to provide an accurate determination of readability for a body of text.

The claimed method includes determining if a target word is contained in a database, and obtaining a syllable count from the database if the word is found therein. If the target word is not found in the database, a query is presented to a user asking for specification of the number of syllables contained in the word. In preferred embodiments, the target word can be added to the database for future reference. As the software is used, this causes the dictionary to grow, and the need for a user to answer queries thereby decreases. Since many application environments make use of specialized vocabularies, this approach allows the software to rapidly adapt itself to usage within a specialized environment, without any need for a programmer to customize the software.

One general aspect of the invention is an article of manufacture for determining the number of syllables in a target word. The article of manufacture includes computer-readable media containing software that is able to direct the actions of a computer so as to cause the computer to:

determine whether the target word is included in a database, the database containing a plurality of words, each word being associated with a syllable count;

if the target word is included in the database, determine the number of syllables in the target word using the associated syllable count; and

if the target word is not included in the database:
present to a user of the computer a query asking for the number of syllables in the target word; and
accept from the user input specifying the number of syllables in the target word.

In preferred embodiments, if the target word is not included in the database, the software is further able to cause the computer to add the target word to the database and associate the number of syllables with the target word in the database.

In some preferred embodiments, if the target word is not included in the database, the software is further able to cause the computer to:

present to a user of the computer a query asking whether the target word should be added to the database; and

if the user indicates that the target word should be added to the database, add the target word to the database and associate the number of syllables with the target word in the database.

In various preferred embodiments, the computer readable media further contains the database containing the plurality of words, each word being associated with a syllable count. And in certain preferred embodiments, the database is a Microsoft Access database, and the software is written in the Microsoft Access Visual Basic for Applications language.

In preferred embodiments, the software is further able to cause the computer to accept input text and perform at least one of:

determining a total number of sentences contained in the input text;

determining a total number of words contained in the input text;

determining a total number of syllables contained in the input text;

determining a total number of words included in a sentence contained in the input text;

for each sentence contained in the input text, determining a total number of words included in the sentence;

determining a total number of syllables included in a sentence contained in the input text;

for each sentence contained in the input text, determining a total number of syllables included in the sentence;

for each word contained in the input text, determining a total number of syllables included in the word;

determining an average number of words per sentence;

determining an average number of syllables per sentence;

determining an average number of syllables per word; and

applying a readability formula so as to determine a readability score of the input text.

In some of these preferred embodiments, the readability formula is one of:

the Powers-Sumner-Kearl readability formula;

the Flesch Grade Level readability formula;

the FOG readability formula;

the SMOG readability formula;

the FRY graph readability formula; and

the FORECAST readability formula.

Another general aspect of the present invention is an apparatus for determining the number of syllables in a target word. The apparatus includes:

a computer;

a database accessible to the computer, the database containing a plurality of words, each word being associated with a syllable count; and

software operable on the computer, the software being able to direct the actions of the computer so as to cause the computer to:

determine whether the target word is included in the database,

if the target word is included in the database, determine the number of syllables in the target word using the syllable count in the database that corresponds to the target word; and

if the target word is not included in the database:
present to a user of the computer a query asking for the number of syllables in the target word; and
accept from the user input specifying the number of syllables in the target word.

In preferred embodiments, if the target word is not included in the database, the software is further able to cause the computer to add the target word to the database and associate the number of syllables with the target word in the database.

In some preferred embodiments, if the target word is not included in the database, the software is further able to cause the computer to:

present to a user of the computer a query asking whether the target word should be added to the database; and

if the user indicates that the target word should be added to the database, add the target word to the database and associate the number of syllables with the target word in the database.

In various preferred embodiments, the database can be accessed by the computer at least one of locally and through a network, the network being one of:

a local network;

a wide area network; and

the internet.

In certain preferred embodiments, the database is a Microsoft Access database, and the software is written in the Microsoft Access Visual Basic for Applications language.

In various preferred embodiments, the software is further able to cause the computer to accept input text and perform at least one of:

determining a total number of sentences contained in the input text;

determining a total number of words contained in the input text;

determining a total number of syllables contained in the input text;

determining a total number of words included in a sentence contained in the input text;

for each sentence contained in the input text, determining a total number of words included in the sentence;

determining a total number of syllables included in a sentence contained in the input text;

for each sentence contained in the input text, determining a total number of syllables included in the sentence;

for each word contained in the input text, determining a total number of syllables included in the word;

determining an average number of words per sentence;

determining an average number of syllables per sentence;

determining an average number of syllables per word; and

applying a readability formula so as to determine a readability score of the input text.

And in some of these preferred embodiments, the readability formula is one of:

the Powers-Sumner-Kearl readability formula;

the Flesch Grade Level readability formula;

the FOG readability formula;

the SMOG readability formula;

the FRY graph readability formula; and

the FORECAST readability formula.

Yet another general aspect of the present invention is an article of manufacture for determining a readability score applicable to a body of text. The article of manufacture includes:

computer-readable media containing software that is able to direct the actions of a computer so as to cause the computer to:

accept input of the body of text;

obtain statistical data from the body of text; and

apply a readability formula to the statistical data so as to determine a readability score of the body of text;

wherein obtaining statistical data includes determining the number of syllables in a target word, by:

determining whether the target word is included in a database, the database containing a plurality of words, each word being associated with a syllable count;

if the target word is included in the database, determining the number of syllables in the target word using the associated syllable count; and

if the target word is not included in the database:
presenting to a user of the computer a query asking for the number of syllables in the target word; and
accepting from the user input specifying the number of syllables in the target word.

In preferred embodiments, if the target word is not included in the database, the software is further able to cause the computer to add the target word to the database and associate the number of syllables with the target word in the database.

In certain preferred embodiments, if the target word is not included in the database, the software is further able to cause the computer to:

present to a user of the computer a query asking whether the target word should be added to the database; and

if the user indicates that the target word should be added to the database, add the target word to the database and associate the number of syllables with the target word in the database.

In various preferred embodiments, the software is further able to cause the computer to accept input text and perform at least one of:

determining a total number of sentences contained in the input text;

determining a total number of words contained in the input text;

determining a total number of syllables contained in the input text;

determining a total number of words included in a sentence contained in the input text;

for each sentence contained in the input text, determining a total number of words included in the sentence;

determining a total number of syllables included in a sentence contained in the input text;

for each sentence contained in the input text, determining a total number of syllables included in the sentence;

for each word contained in the input text, determining a total number of syllables included in the word;

determining an average number of words per sentence;

determining an average number of syllables per sentence; and

determining an average number of syllables per word.

In some preferred embodiments, the database is a Microsoft Access database, and the software is written in the Microsoft Access Visual Basic for Applications language.

And in other preferred embodiments the readability formula is one of:

the Powers-Sumner-Kearl readability formula;

the Flesch Grade Level readability formula;

the FOG readability formula;

the SMOG readability formula;

the FRY graph readability formula; and

the FORECAST readability formula.

### BRIEF DESCRIPTION OF THE DRAWINGS

The invention will be more fully understood by reference to the detailed description, in conjunction with the following figures, wherein:

FIG. 1 is a flow diagram that illustrates a general method for determining a readability score for an item of text;

FIG. 2 is a flow diagram illustrating a typical method of the prior art for determining the number of syllables in a target word;

FIG. 3 is a flow diagram that illustrated the method of the present invention for determining the number of syllables in a target word; and

FIG. 4 is a table that illustrates a database in a preferred embodiment that includes records containing words and syllable counts corresponding to the words.

### DETAILED DESCRIPTION OF PREFERRED EMBODIMENTS

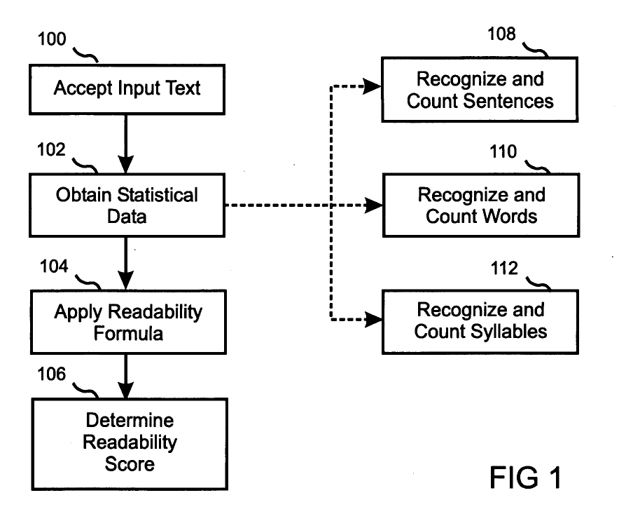

With reference to FIG. 1, a general method used for determining a readability score for an item of text begins with accepting the item of text 100 and extracting from the text certain statistical information 102. A readability formula is then applied to the statistical information 104, thereby providing a readability score 106, often expressed in terms of an “equivalent grade level.” For example, if the readability formula determines 104 that an item of text is written at a “sixth grade” level, then it should be possible for any native language speaker who has completed the sixth grade in school to read and comprehend the text without undue difficulty. Typically, the method is implemented on a computer.

A number of different readability formulae are in general use for determining readability scores 104. Examples include Powers-Sumner-Kearl, Flesch Grade Level, FOG, SMOG, FRY graph, and FORECAST. Different types of statistical information are required by different formulae, but in general it is necessary for the computer to recognize and count sentences 108, words 110, and syllables 112 so as to compile the statistical information required by the readability formula. Sentences are generally easy for a computer to differentiate due to recognizable punctuation marks that separate sentences, such as periods, question marks, and exclamation marks. Similarly, words are usually easy for a computer to differentiate, due to the spaces included between the words.

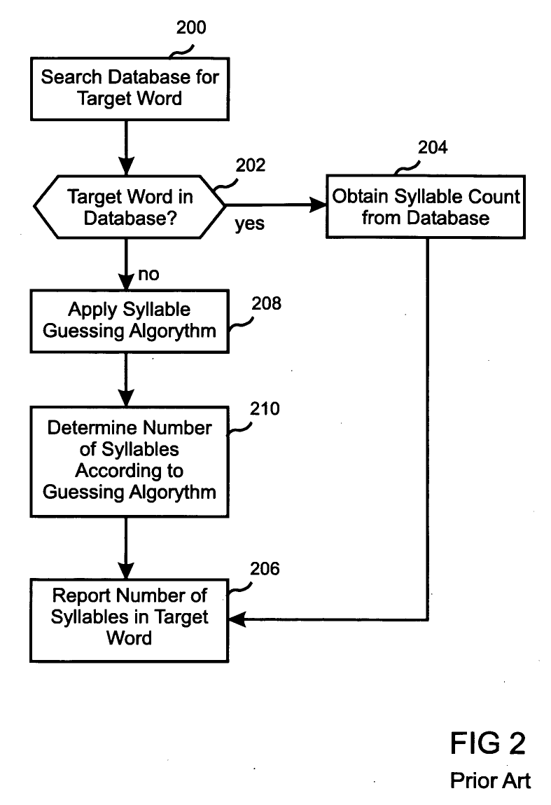

However, syllables within a word are not easy for a computer to differentiate. FIG. 2 illustrates a method frequently employed in the prior art for attempting to determine the number of syllables in a target word. The software begins by searching a database to see if the target word is included therein 200. The database functions as a dictionary, and includes a plurality of words and a syllable count associated with each word. The database is typically supplied together with the readability determining software, but can also be supplied separately. It can be accessed locally within the computer, over a local or wide area network, or over the internet.

If the target word is found in the database 202, then the corresponding syllable count is obtained from the database 204, and reported as the number of syllables in the word 206. However, if the target word is not found in the database 202, a syllable guessing algorythm is employed 208 in an attempt to guess the number of syllables in the word.

Some of the rules used in syllable guessing algorythms 208 are straightforward and generally accurate. For example, if a similar word is found in the database, except that the target word includes the letter “s” at the end, then it is assumed that the additional “s” does not add a syllable, and that the number of syllables in the target word is equal to the syllable count from the database corresponding to the same word without the terminal “s.” Similarly, if a word equivalent to the target word is found in the database, except that the target word includes the letters “ing” at the end, it is assumed that the additional letters add a syllable, and that the number of syllables in the target word is one more than the syllable count from the database corresponding to the equivalent word without the terminal “ing.”

While the examples just presented are generally accurate, many of the commonly used syllable guessing rules 204 are unreliable. They typically depend on lists of grammatical rules and exceptions to those rules, often resulting in incorrect determinations as to the number of syllables in a word.

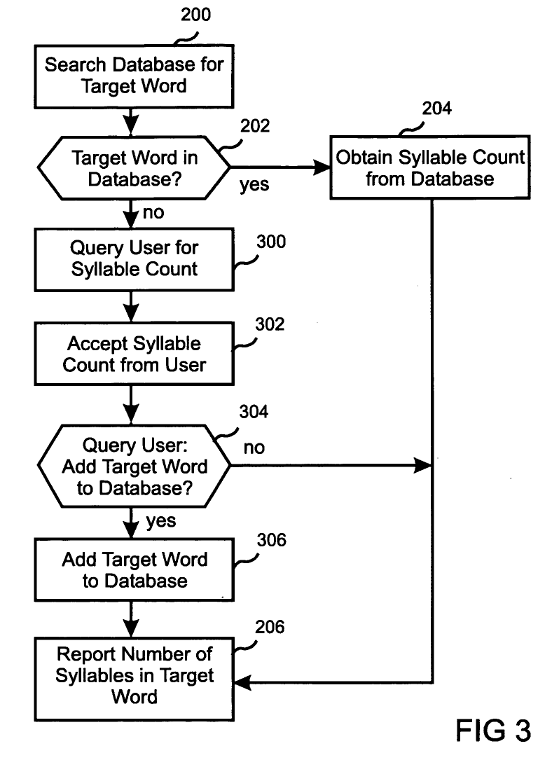

With reference to FIG. 3, the present invention also searches a database 200 to see if a target word is contained therein. However, the present invention does not resort to guessing algorythms if the target word is not found in the database. Instead, a query is displayed 300 to a user of the system, that prompts the user to respond with the number of syllables in the target word. This provides accurate and reliable input 302 for use by the readability formula.

In preferred embodiments, the software then queries the user 304 as to whether or not the target word should be added to the database, and if the user so indicates, the target word is added to the database 306 for future reference. In similar embodiments, the target word is automatically added to the database for future reference without any additional query of the user.

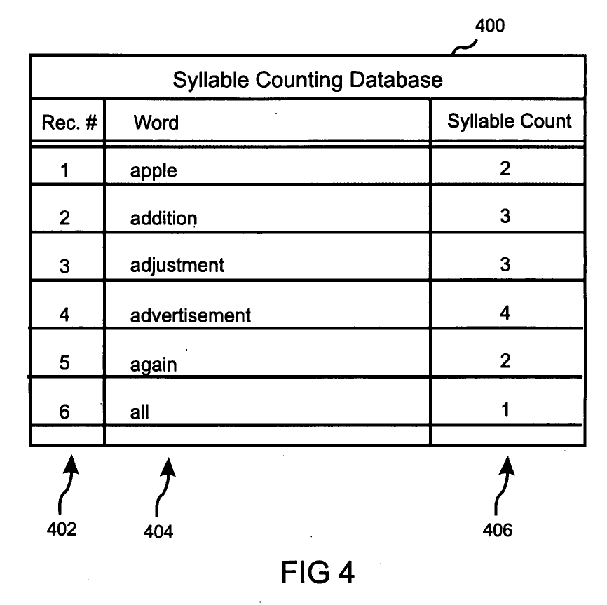

FIG. 4 presents a table 400 illustrating the structure of the database used in some embodiments of the present invention. The database includes a plurality of records 402, each record including a word 404 and a corresponding syllable count 406 applicable to the word 404. The software is thereby able to search the words 404, which are typically indexed, and if the target word is found, the corresponding syllable count 406 provides the number of syllables in the target word. In similar embodiments, the database 400 is a relational database, and the syllable counts are maintained in a separate table that is related to the table of words.

Other modifications and implementations will occur to those skilled in the art without departing from the spirit and the scope of the invention as claimed. Accordingly, the above description is not intended to limit the invention except as indicated in the following claims.

What is claimed is:

1. An article of manufacture for determining the number of syllables in a target word, the article of manufacture comprising:
computer-readable media containing software that is able to direct the actions of a computer so as to cause the computer to:
determine whether the target word is included in a database, the database containing a plurality of words, each word being associated with a syllable count;
if the target word is included in the database, determine the number of syllables in the target word using the associated syllable count; and
if the target word is not included in the database:
present to a user of the computer a query asking for the number of syllables in the target word; and
accept from the user input specifying the number of syllables in the target word.

2. The article of manufacture of claim 1, wherein if the target word is not included in the database, the software is further able to cause the computer to add the target word to the database and associate the number of syllables with the target word in the database.

3. The article of manufacture of claim 1, wherein if the target word is not included in the database, the software is further able to cause the computer to:
present to a user of the computer a query asking whether the target word should be added to the database; and
if the user indicates that the target word should be added to the database, add the target word to the database and associate the number of syllables with the target word in the database.

4. The article of manufacture of claim 1, wherein the computer readable media further contains the database containing the plurality of words, each word being associated with a syllable count.

5. The article of manufacture of claim 1, wherein the database is a Microsoft Access database, and the software is written in the Microsoft Access Visual Basic for Applications language.

6. The article of manufacture of claim 1, wherein the software is further able to cause the computer to accept input text and perform at least one of:
determining a total number of sentences contained in the input text;
determining a total number of words contained in the input text;
determining a total number of syllables contained in the input text;
determining a total number of words included in a sentence contained in the input text;
for each sentence contained in the input text, determining a total number of words included in the sentence;
determining a total number of syllables included in a sentence contained in the input text;
for each sentence contained in the input text, determining a total number of syllables included in the sentence;
for each word contained in the input text, determining a total number of syllables included in the word;
determining an average number of words per sentence;
determining an average number of syllables per sentence;
determining an average number of syllables per word; and
applying a readability formula so as to determine a readability score of the input text.

7. The article of manufacture of claim 6, wherein the readability formula is one of:
the Powers-Sumner-Kearl readability formula;
the Flesch Grade Level readability formula;
the FOG readability formula;
the SMOG readability formula;
the FRY graph readability formula; and
the FORECAST readability formula.

8. An apparatus for determining the number of syllables in a target word, the apparatus comprising:
a computer;
a database accessible to the computer, the database containing a plurality of words, each word being associated with a syllable count; and
software operable on the computer, the software being able to direct the actions of the computer so as to cause the computer to:
determine whether the target word is included in the database,
if the target word is included in the database, determine the number of syllables in the target word using the syllable count in the database that corresponds to the target word; and
if the target word is not included in the database:
present to a user of the computer a query asking for the number of syllables in the target word; and
accept from the user input specifying the number of syllables in the target word.

9. The apparatus of claim 8, wherein if the target word is not included in the database, the software is further able to cause the computer to add the target word to the database and associate the number of syllables with the target word in the database.

10. The apparatus of claim 8 wherein, if the target word is not included in the database, the software is further able to cause the computer to:
present to a user of the computer a query asking whether the target word should be added to the database; and
if the user indicates that the target word should be added to the database, add the target word to the database and associate the number of syllables with the target word in the database.

11. The apparatus of claim 8 wherein the database can be accessed by the computer at least one of locally and through a network, the network being one of:
a local network;
a wide area network; and
the internet.

12. The apparatus of claim 8 wherein the database is a Microsoft Access database, and the software is written in the Microsoft Access Visual Basic for Applications language.

13. The apparatus of claim 8 wherein the software is further able to cause the computer to accept input text and perform at least one of:
determining a total number of sentences contained in the input text;
determining a total number of words contained in the input text;
determining a total number of syllables contained in the input text;
determining a total number of words included in a sentence contained in the input text;
for each sentence contained in the input text, determining a total number of words included in the sentence;
determining a total number of syllables included in a sentence contained in the input text;
for each sentence contained in the input text, determining a total number of syllables included in the sentence;
for each word contained in the input text, determining a total number of syllables included in the word;
determining an average number of words per sentence;
determining an average number of syllables per sentence;
determining an average number of syllables per word; and
applying a readability formula so as to determine a readability score of the input text.

14. The apparatus of claim 13 wherein the readability formula is one of:
the Powers-Sumner-Kearl readability formula;
the Flesch Grade Level readability formula;
the FOG readability formula;
the SMOG readability formula;
the FRY graph readability formula; and
the FORECAST readability formula.

15. An article of manufacture for determining a readability score applicable to a body of text, the article of manufacture comprising:
computer-readable media containing software that is able to direct the actions of a computer so as to cause the computer to:
accept input of the body of text;
obtain statistical data from the body of text; and
apply a readability formula to the statistical data so as to determine a readability score of the body of text;
wherein obtaining statistical data includes determining the number of syllables in a target word, by:
determining whether the target word is included in a database, the database containing a plurality of words, each word being associated with a syllable count;
if the target word is included in the database, determining the number of syllables in the target word using the associated syllable count; and
if the target word is not included in the database:
presenting to a user of the computer a query asking for the number of syllables in the target word; and
accepting from the user input specifying the number of syllables in the target word.

16. The article of manufacture of claim 15, wherein if the target word is not included in the database, the software is further able to cause the computer to add the target word to the database and associate the number of syllables with the target word in the database.

17. The article of manufacture of claim 15, wherein if the target word is not included in the database, the software is further able to cause the computer to:
present to a user of the computer a query asking whether the target word should be added to the database; and
if the user indicates that the target word should be added to the database, add the target word to the database and associate the number of syllables with the target word in the database.

18. The article of manufacture of claim 15, wherein the software is further able to cause the computer to accept input text and perform at least one of:
determining a total number of sentences contained in the input text;
determining a total number of words contained in the input text;
determining a total number of syllables contained in the input text;
determining a total number of words included in a sentence contained in the input text;
for each sentence contained in the input text, determining a total number of words included in the sentence;
determining a total number of syllables included in a sentence contained in the input text;
for each sentence contained in the input text, determining a total number of syllables included in the sentence;
for each word contained in the input text, determining a total number of syllables included in the word;
determining an average number of words per sentence;
determining an average number of syllables per sentence; and
determining an average number of syllables per word.

19. The article of manufacture of claim 15, wherein the database is a Microsoft Access database, and the software is written in the Microsoft Access Visual Basic for Applications language.

20. The article of manufacture of claim 15, wherein the readability formula is one of:
the Powers-Sumner-Kearl readability formula;
the Flesch Grade Level readability formula;
the FOG readability formula;
the SMOG readability formula;
the FRY graph readability formula; and
the FORECAST readability formula.
